(19) United States
(12) Patent Application Publication
(10) Pub. No.: US 2026/0212007 A1
(43) Pub. Date: Jul. 23, 2026

(54) SYSTEM AND METHOD FOR GENERATING AND OPERATING A CLUSTER OF VIRTUAL OPERATING ENVIRONMENTS TO MIRROR INCOMING APPLICATION REQUESTS

(71) Applicant: BANK OF AMERICA CORPORATION, Charlotte, NC (US)

(72) Inventor: Timothy Andrew Wright, Sandhurst (GB)

(73) Assignee: BANK OF AMERICA CORPORATION, Charlotte, NC (US)

(21) Appl. No.: 19/033,213

(22) Filed: Jan. 21, 2025

(51) Int. Cl. G06F 21/55

(52) U.S. Cl. CPC G06F 21/554; G06F 2221/033

(57) ABSTRACT

Embodiments of the present invention provide a system for generating and operating a cluster of virtual operating environments to mirror incoming application requests. The system is configured to receive an application request associated with an entity application, mirror the application request to generate a mirrored application request, parallelly transmit the application request to a security application and the mirrored application request to a mirrored environment controller application, wherein the security application determines if the application request is malicious before the application request is transmitted to the entity application, wherein in parallel to steps performed by the security application, the mirrored environment controller application creates virtual environments for executing the mirrored application request, analyzes execution of the mirrored application request in the virtual environments to determine if the mirrored application request is malicious and performs one or more actions based on whether the mirror application request is malicious.

### BACKGROUND

There exists a need for a system that can identify whether incoming application requests associated with one or more applications of an entity are malicious.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for generating and operating a cluster of virtual operating environments to mirror incoming application requests. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention receives an incoming application request associated with an entity application associated with an entity, mirror the incoming application request to generate a mirrored incoming application request, parallelly transmits the incoming application request to a security application and the mirrored incoming application request to a mirrored environment controller application, wherein the security application determines if the incoming application request is malicious before the incoming application request is transmitted to the entity application, wherein in parallel to execution steps performed by the security application, the mirrored environment controller application (i) creates one or more virtual environments for executing the mirrored incoming application request, (ii) executes the mirrored incoming application request in the one or more virtual environments, (iii) monitors and records execution of the mirrored incoming application request in the one or more virtual environments, (iv) transmits data associated with the execution of the mirrored incoming application request in the one or more virtual environments to an artificial intelligence engine, (v) analyzes, via the artificial intelligence engine, the data associated with the execution of the mirrored incoming application request in the one or more virtual environments to determine if the mirrored incoming application request is malicious, and (vi) performs one or more actions based on determining if the mirrored incoming application request is malicious.

In some embodiments, the security application determines if the incoming application request is malicious based on one or more security rules.

In some embodiments, the security application determines if the incoming application request is malicious based on one or more factors associated with the incoming application request.

In some embodiments, the security application determines that the incoming application request is malicious and blocks the transmission of the incoming application request to the entity application.

In some embodiments, the present invention analyzes, via the artificial intelligence engine, the data associated with the execution of the mirrored incoming application request in the one or more virtual environments to determine if the mirrored incoming application request is malicious based on one or more exposure indicators.

In some embodiments, the one or more actions comprise stopping analysis if the artificial intelligence engine determines that the mirrored incoming application request is not malicious, transmitting the analysis to a user associated with the entity application for review if the determination by the artificial intelligence engine whether the mirrored incoming application request is inconclusive, and generating and storing one or more security rules to mitigate exposures associated with the mirrored incoming application request if the artificial intelligence engine determines that the mirrored incoming application request is malicious.

In some embodiments, the one or more virtual environments are generated in real-time.

In some embodiments, the one or more virtual environments comprise one or more characteristics of an application environment associated with the entity application.

In some embodiments, the mirrored environment controller application determines one or more operating system versions supported by the entity application and generates the one or more virtual environments for each of the one or more operating system versions.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for generating and operating a cluster of virtual operating environments to mirror incoming application requests, in accordance with an embodiment of the invention;

FIG. 2 provides a block diagram illustrating the entity system 200 of FIG. 1, in accordance with an embodiment of the invention;

FIG. 3 provides a block diagram illustrating an incoming application request analysis system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for generating and operating a cluster of virtual operating environments to mirror incoming application requests, in accordance with an embodiment of the invention; and

FIG. 6 provides a block diagram illustrating the process of generating and operating a cluster of virtual operating environments to mirror incoming application requests, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that uses one or more applications for implementing/executing one or more actions associated with the entity, where the one or more applications receive one or more application requests from one or more users associated with the entity to perform the one or more actions. In some embodiments, the entity may be a financial institution which may include herein may include any financial institutions such as commercial banks, thrifts, federal and state savings banks, savings and loan associations, credit unions, investment companies, insurance companies and the like. In some embodiments, the entity may be a non-financial institution. As described herein, a “user” may be an employee, a customer, or a potential customer of the entity.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

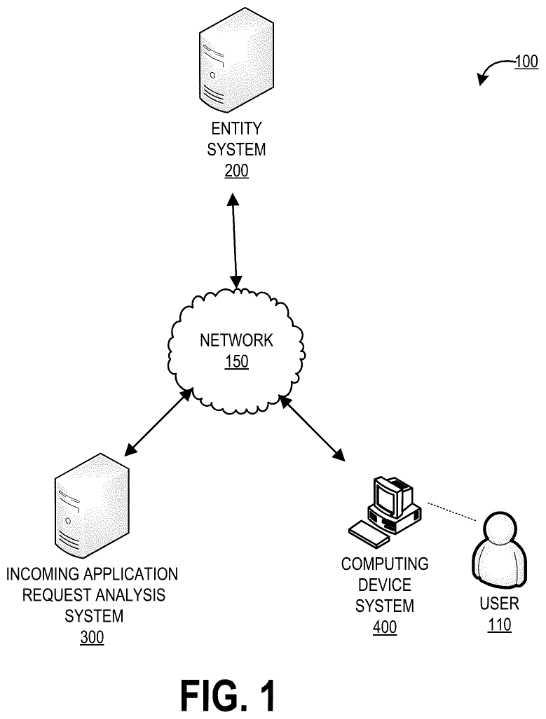

FIG. 1 provides a block diagram illustrating a system environment 100 for generating and operating a cluster of virtual operating environments to mirror incoming application requests, in accordance with an embodiment of the invention. As illustrated in FIG. 1, the environment 100 includes an incoming application request analysis system 300, an entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200. In some embodiments, the one or more users 110 may be potential customers of the entity associated with the entity system 200. In some embodiments, the one or more users 110 may be employees of the entity associated with the entity system 200.

The entity system(s) 200 may be any system owned or otherwise controlled by an entity to support or perform one or more process steps described herein. In some embodiments, the entity may be any organization that develops, tests, manages, maintains, uses, and/or the like one or more software applications for performing one or more activities associated with the entity. In some embodiments, the entity is a financial institution. In some embodiments, the entity is a non-financial institution. In some embodiments, the one or more software applications may be developed by the entity. In some embodiments, one or more parts of the software code associated with the one or more software applications may be developed by other entities and utilized by the entity.

The incoming application request analysis system 300 is a system of the present invention for performing one or more process steps described herein. In some embodiments, the incoming application request analysis system 300 may be an independent system. In some embodiments, the incoming application request analysis system 300 may be a part of the entity system 200. In some embodiments, the incoming application request analysis system 300 may be controlled, owned, managed, and/or maintained by the entity associated with the entity system 200.

The incoming application request analysis system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the incoming application request analysis system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the incoming application request analysis system 300, and/or entity system 200 across the network 150.

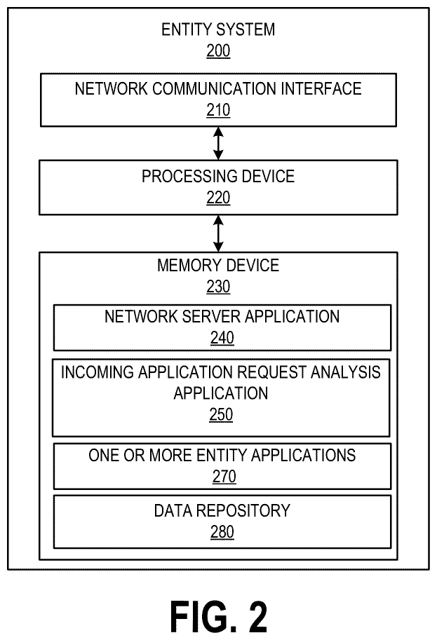

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution or a non-financial institution.

It should be understood that the memory device 230 may include one or more databases or other data structures/repositories. The memory device 230 also includes computer-executable program code that instructs the processing device 220 to perform one or more processing functionalities described herein and also to operate the network communication interface 210 to perform certain communication functions of the entity system 200 described herein. For example, in one embodiment of the entity system 200, the memory device 230 includes, but is not limited to, an incoming application request analysis application 250, one or more entity applications 270, and a data repository 280. The one or more entity applications 270 may be any applications developed, supported, maintained, utilized, and/or controlled by the entity. The computer-executable program code of the network server application 240, the incoming application request analysis application 250, the one or more entity application 270 to perform certain logic, data-extraction, and data-storing functions of the entity system 200 described herein, as well as communication functions of the entity system 200.

The network server application 240, the incoming application request analysis application 250, and the one or more entity applications 270 are configured to store data in the data repository 280 or to use the data stored in the data repository 280 when communicating through the network communication interface 210 with the incoming application request analysis system 300, and/or the computing device system 400 to perform one or more process steps described herein. In some embodiments, the entity system 200 may receive instructions from the incoming application request analysis system 300 via the incoming application request analysis application 250 to perform certain operations. The incoming application request analysis application 250 may be provided by the incoming application request analysis system 300. The one or more entity applications 270 may be any of the applications used, created, modified, facilitated, developed, and/or managed by the entity system 200.

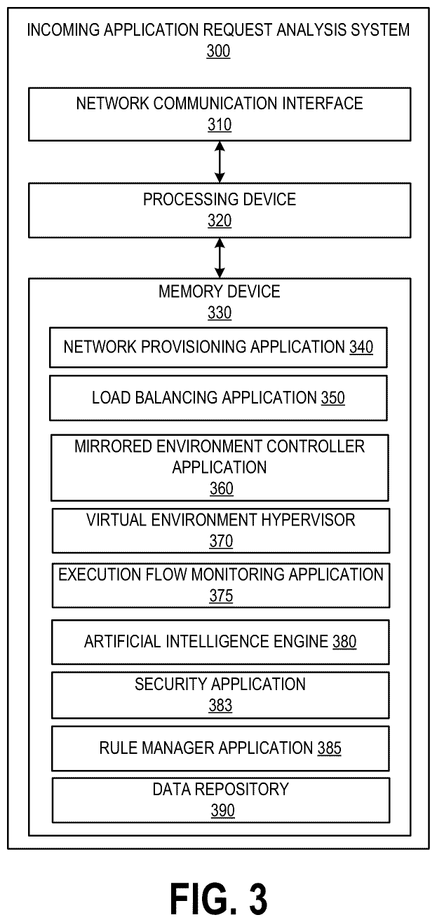

FIG. 3 provides a block diagram illustrating the incoming application request analysis system 300 in greater detail, in accordance with embodiments of the invention. As illustrated in FIG. 3, in one embodiment of the invention, the incoming application request analysis system 300 includes one or more processing devices 320 operatively coupled to a network communication interface 310 and a memory device 330. In certain embodiments, the incoming application request analysis system 300 is operated by an entity, such as a financial institution. In some embodiments, the incoming application request analysis system 300 is owned or operated by the entity of the entity system 200. In some embodiments, the incoming application request analysis system 300 may be an independent system. In alternate embodiments, the incoming application request analysis system 300 may be a part of the entity system 200.

It should be understood that the memory device 330 may include one or more databases or other data structures/repositories. The memory device 330 also includes computer-executable program code that instructs the processing device 320 to perform processing operations described herein and to operate the network communication interface 310 to perform certain communication functions of the incoming application request analysis system 300. For example, in one embodiment of the incoming application request analysis system 300, the memory device 330 includes, but is not limited to, a network provisioning application 340, a load balancing application 350, a mirrored environment controller 360, a virtual environment hypervisor 370, an artificial intelligence engine 380, a security application 383, a rule manager application 385, and a data repository 390 comprising any data processed or accessed by one or more applications in the memory device 330. The computer-executable program code of the network provisioning application 340, the load balancing application 350, the mirrored environment controller 360, the virtual environment hypervisor 370, the artificial intelligence engine 380, the security application 383, and the rule manager application 385 may instruct the processing device 320 to perform certain logic, data-processing, and data-storing functions of the incoming application request analysis system 300 described herein, as well as communication functions of the incoming application request analysis system 300.

The network provisioning application 340, the load balancing application 350, the mirrored environment controller 360, the virtual environment hypervisor 370, the artificial intelligence engine 380, the security application 383, and the rule manager application 385 are configured to invoke or use the data in the data repository 390 when communicating through the network communication interface 310 with the entity system 200, and/or the computing device system 400. In some embodiments, the network provisioning application 340, the load balancing application 350, the mirrored environment controller 360, the virtual environment hypervisor 370, the artificial intelligence engine 380, the security application 383, and the rule manager application 385 may store the data extracted or received from the entity system 200, and the computing device system 400 in the data repository 390. In some embodiments, the network provisioning application 340, the load balancing application 350, the mirrored environment controller 360, the virtual environment hypervisor 370, the artificial intelligence engine 380, the security application 383, and the rule manager application 385 may be a part of a single application (e.g., modules).

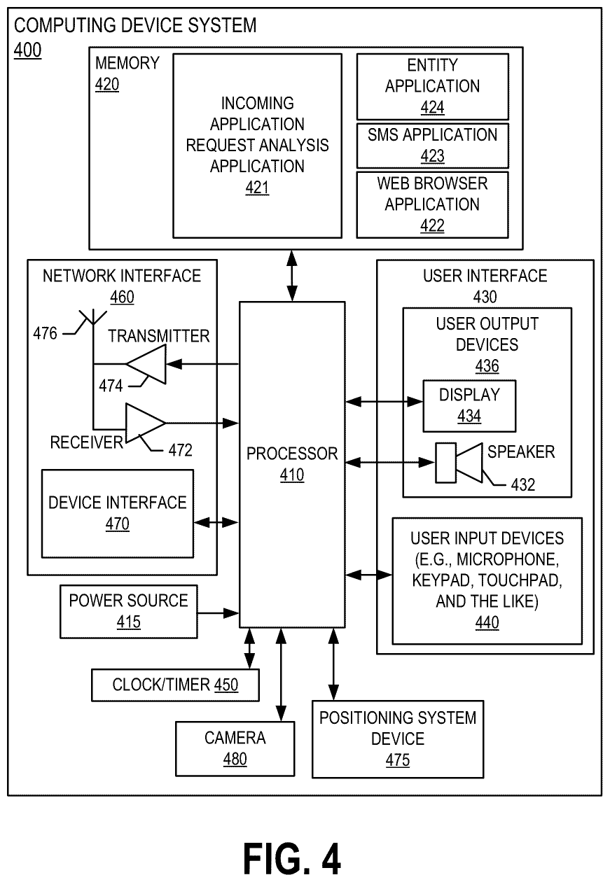

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a incoming application request analysis application 421, entity application 424. These applications also typically instructions to a graphical user interface (GUI) on the display 430 that allows the user 110 to interact with the entity system 200, the incoming application request analysis system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the incoming application request analysis application 421 provided by the incoming application request analysis system 300 allows the user 110 to access the incoming application request analysis system 300. In some embodiments, the entity application 424 provided by the entity system 200 and the incoming application request analysis application 421 allow the user 110 to access the functionalities provided by the incoming application request analysis system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

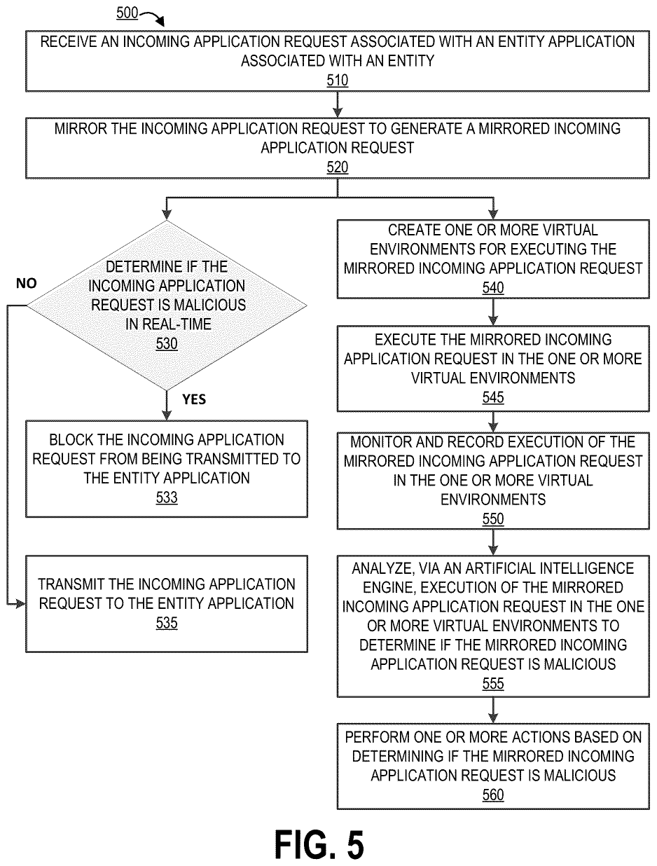

FIG. 5 provides a flowchart 500 illustrating a process flow for generating and operating a cluster of virtual operating environments to mirror incoming application requests, in accordance with an embodiment of the invention. In some embodiments, one or more steps of the process flow 500 may be implemented via a quantum optimizer to improve the efficiency of processing one or more incoming application requests and also determining if the one or more incoming application requests are malicious or not.

As shown in block 510, the system receives an incoming application request associated with an entity application associated with an entity. In some embodiments, the entity application may be any application developed, used, managed, maintained, and/or the like by the entity. In some embodiments, the entity application may be an application used by one or more employees of the entity. In some embodiments, the entity application may be an application provided to one or more customers associated with the entity. In some embodiments, the system may receive multiple requests associated with multiple applications associated with the entity. In some embodiments, the system may process incoming multiple requests associated with multiple applications in parallel. In some embodiments, the incoming application request may be initiated by an authorized user authorized to use the entity application. In some embodiments, the incoming application request may be initiated by an unauthorized user (e.g., malicious actor).

As shown in block 520, the system mirrors the incoming application request to generate a mirrored incoming application request. Mirroring the incoming application request comprises replicating data associated with the incoming application request, and/or the like. As shown, after this step, the process flow described in block 530 and block 540 runs in parallel, where the system processes the incoming application request in real-time (after determining if the incoming application request is malicious or not) to prevent a delay in response if user submitting the incoming application request is an authorized application user of the entity application, and where the system in parallel to processing the incoming application request, also analyzes the mirrored incoming application request to determine if the execution of the mirrored incoming application request is malicious or not.

As shown in block 530, the system determines if the incoming application request is malicious in real-time. In some embodiments, the system determines if the incoming application request is malicious or not in real-time based on one or more security rules. The one or more security rules are rules generated by the system to block malicious application requests from reaching the entity application based historical analysis of similar requests performed by the system at a previous time period. The process of analyzing the incoming application requests in discussed in detail below in block 540 through block 560. The one or more security rules may be rules associated with IP address, data characteristics, sender information, signatures, execution steps, and/or the like associated with the incoming application requests. For example, the system may determine that an incoming application request performs one or more execution steps that are similar to execution steps of previously determined malicious request, the system may determine the incoming application request as malicious. In one embodiment, where the system determines that the incoming application request is malicious the process flow proceeds to block 533, where, as shown in block 533, the system blocks the incoming application request from being transmitted to the entity application. In one embodiment, where the system determines that the incoming application request is malicious the process flow proceeds to block 533, where, as shown in block 535, the system transmits the incoming application request to the entity application.

As shown in block 540, the system creates one or more virtual environments for executing the mirrored incoming application request. In parallel to processing the incoming application request to prevent a delay in responding to the request if the request was initiated by an authorized user, the system analyzes the mirrored incoming application request by creating one or more virtual environments. In some embodiments, the system may create virtual environments for each of the one or more operating system versions that the entity application supports. For example, if the entity application supports a first operating system, a second operating system, and a third operating system, the system generates a virtual environment for each of the first operating system, the second operating system, and the third operating system. In some embodiments, the entity application may support ‘n’ operating systems. In some embodiments, the system may determine the one or more operating system versions that the entity application supports based on accessing application data associated with the entity application, where the application data may be stored in an entity database associated with an entity system (e.g., data repository 280). In some embodiments, the system may create virtual environments for additional factors associated with the entity application and are not limited to the operating systems that the entity application supports.

As shown in block 545, the system executes the mirrored incoming application request in the one or more virtual environments. In some embodiments, the system may place the one or more mirrored incoming application requests in a queue, prioritize the one or more mirrored incoming application requests (e.g., based on application type, availability of resources to generate virtual environments, type of application requests, type of users, and/or the like), and implement one or more of the mirrored incoming application requests at an instance based on priority. As shown in block 550, the system monitors and records execution of the mirrored incoming application request in the one or more virtual environments.

As shown in block 555, the system analyzes, via an artificial intelligence engine, execution of the mirrored incoming application request in the one or more virtual environments to determine if the mirrored incoming application request is malicious. In some embodiments, the artificial intelligence engine may identify one or more trends or patterns associated with the recorded execution flows/steps associated with the mirrored incoming application requests in the one or more virtual environments to determine any anomalies. For example, if an execution step is trying to change configurations of the entity application, download datafiles, access restricted data, and/or the like, the system may determine such an execution step as an anomaly. In some embodiments, the analysis performed by the artificial intelligence engine may be based on exposure indicators. Exposure indicators may comprise unusual outbound network traffic, anomalies in user account activity, geographical irregularities, unusual login attempts, HTML response sizes, large number of requests for the same file, mismatches port-application traffic, suspicious registry, suspicious system file changes, DNS request anomalies, and/or the like.

As shown in block 560, the system performs one or more actions based on determining if the mirrored incoming application request is malicious. The one or more actions may comprise stopping analysis if the artificial intelligence engine determines that the mirrored incoming application request is not malicious, transmitting the analysis to a user associated with the entity application for review if the determination by the artificial intelligence engine whether the mirrored incoming application request is inconclusive, and generating and storing one or more security rules to mitigate exposures associated with the mirrored incoming application request if the artificial intelligence engine determines that the mirrored incoming application request is malicious.

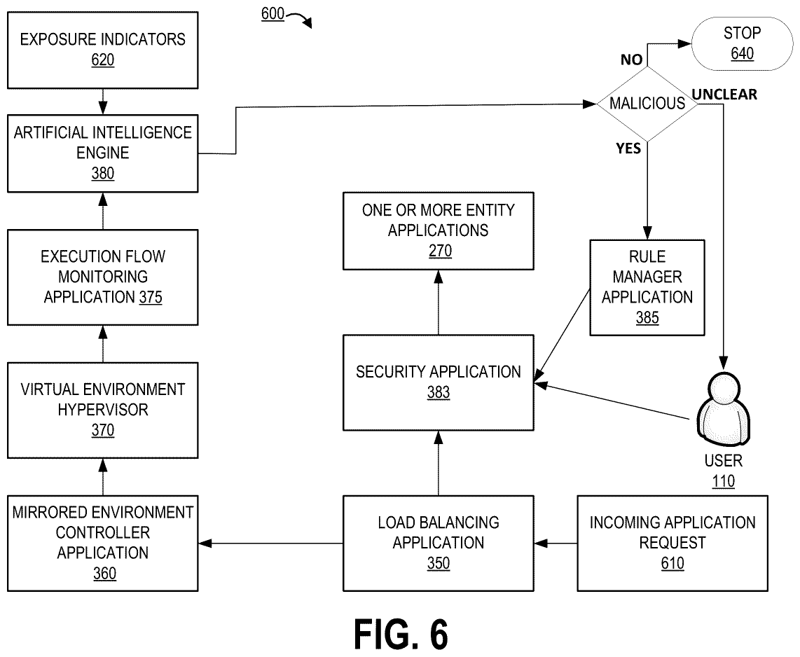

FIG. 6 provides a block diagram illustrating the process of generating and operating a cluster of virtual operating environments to mirror incoming application requests, in accordance with an embodiment of the invention. As shown, an incoming application request 610 is received by the load balancing application 350 of the system from a user, where the user may be an authorized user (e.g., user 110) or an unauthorized user (e.g., malicious actor). The incoming application request 610 may be a request associated with any of the one or more entity applications 270. Upon receiving the incoming application request 610, the load balancing application 350 mirrors the incoming application request 610 to generate a mirrored incoming application request and transmit the mirrored incoming application request to the mirrored environment controller application 360 and the incoming application request 610 to the security application 383.

The security application 383, upon receiving the incoming application request 610, analyzes the incoming application request 610 based on one or more security rules stored in the rule manager application 385 to determine if the incoming application request 610 is malicious or not. If the incoming application request 610 is not malicious, the security application 383 may allow the incoming application request 610 to go to the one or more entity applications 270. If the incoming application request 610 is determined to be malicious, the security application 383 will block the incoming application request 610 from being transmitted to the one or more entity applications 270.

The mirrored environment controller application 360, upon receiving the mirrored incoming application request, generates one or more virtual environment by passing instructions to the virtual environment hypervisor 370 and executes the mirrored incoming application request in each of the one or more virtual environments generated in the virtual environment hypervisor 370. During the execution of the mirrored incoming application request in each of the one or more virtual environments, the execution flow monitoring application 375 monitors and records execution steps associated with the execution of the mirrored incoming application request in each of the one or more virtual environments. The mirrored environment controller application 360 then transmits the recorded execution steps to the artificial intelligence engine 380 for analysis. The artificial intelligence engine 380 analyze the execution steps to determine if the mirrored incoming application request is malicious or not based on one or more exposure indicators 620. In the case, where the artificial intelligence 380 determines that the mirrored incoming application request is malicious, the system generates and stores one or more security rules associated with the mirrored incoming application request, via the rule manager application 385, where the one or more security rules are used to determine and block future application requests similar to the mirrored incoming application request that was determined to be malicious. In the case, where the artificial intelligence 380 determines that the mirrored incoming application request is not malicious, the system stops the analyzes as shown in block 640. In the case, where the artificial intelligence 380 is unable to determine if the mirrored incoming application request is malicious or not, the system transmits data associated with the analysis to the user 110 (e.g., application developer, security analyst, and/or any employee associated with the entity and/or the entity application) to make a determination and notify the security application 383.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for generating and operating a cluster of virtual operating environments to mirror incoming application requests, the system comprising:
at least one network communication interface;
at least one non-transitory storage device; and
at least one processing device coupled to the at least one non-transitory storage device and the at least one network communication interface, wherein the at least one processing device is configured to:
receive an incoming application request associated with an entity application associated with an entity;
mirror the incoming application request to generate a mirrored incoming application request;
parallelly transmit the incoming application request to a security application and the mirrored incoming application request to a mirrored environment controller application,
wherein the security application determines if the incoming application request is malicious before the incoming application request is transmitted to the entity application,
wherein in parallel to execution steps performed by the security application, the mirrored environment controller application (i) creates one or more virtual environments for executing the mirrored incoming application request, (ii) executes the mirrored incoming application request in the one or more virtual environments, (iii) monitors and records execution of the mirrored incoming application request in the one or more virtual environments, (iv) transmits data associated with the execution of the mirrored incoming application request in the one or more virtual environments to an artificial intelligence engine, (v) analyzes, via the artificial intelligence engine, the data associated with the execution of the mirrored incoming application request in the one or more virtual environments to determine if the mirrored incoming application request is malicious, and (vi) performs one or more actions based on determining if the mirrored incoming application request is malicious.

2. The system of claim 1, wherein the security application determines if the incoming application request is malicious based on one or more security rules.

3. The system of claim 1, wherein the security application determines if the incoming application request is malicious based on one or more factors associated with the incoming application request.

4. The system of claim 1, wherein the security application determines that the incoming application request is malicious and blocks the transmission of the incoming application request to the entity application.

5. The system of claim 1, wherein the at least one processing device is configured to analyzes, via the artificial intelligence engine, the data associated with the execution of the mirrored incoming application request in the one or more virtual environments to determine if the mirrored incoming application request is malicious based on one or more exposure indicators.

6. The system of claim 1, wherein the one or more actions comprise:
stopping analysis if the artificial intelligence engine determines that the mirrored incoming application request is not malicious;
transmitting the analysis to a user associated with the entity application for review if the determination by the artificial intelligence engine whether the mirrored incoming application request is inconclusive; and
generating and storing one or more security rules to mitigate exposures associated with the mirrored incoming application request if the artificial intelligence engine determines that the mirrored incoming application request is malicious.

7. The system of claim 1, wherein the one or more virtual environments are generated in real-time.

8. The system of claim 7, wherein the one or more virtual environments comprise one or more characteristics of an application environment associated with the entity application.

9. The system of claim 7, wherein the mirrored environment controller application determines one or more operating system versions supported by the entity application and generates the one or more virtual environments for each of the one or more operating system versions.

10. A computer program product for generating and operating a cluster of virtual operating environments to mirror incoming application requests, the computer program product comprising a non-transitory computer-readable storage medium having computer executable instructions for causing a computer processor to perform the steps of:
receiving an incoming application request associated with an entity application associated with an entity;
mirroring the incoming application request to generate a mirrored incoming application request;
parallelly transmitting the incoming application request to a security application and the mirrored incoming application request to a mirrored environment controller application,
wherein the security application determines if the incoming application request is malicious before the incoming application request is transmitted to the entity application,
wherein in parallel to steps performed by the security application, the mirrored environment controller application (i) creates one or more virtual environments for executing the mirrored incoming application request, (ii) executes the mirrored incoming application request in the one or more virtual environments, (iii) monitors and records execution of the mirrored incoming application request in the one or more virtual environments, (iv) transmits data associated with the execution of the mirrored incoming application request in the one or more virtual environments to an artificial intelligence engine, (v) analyzes, via the artificial intelligence engine, the data associated with the execution of the mirrored incoming application request in the one or more virtual environments to determine if the mirrored incoming application request is malicious, and (vi) performs one or more actions based on determining if the mirrored incoming application request is malicious.

11. The computer program product of claim 10, wherein the security application determines if the incoming application request is malicious based on one or more security rules.

12. The computer program product of claim 10, wherein the security application determines that the incoming application request is malicious and blocks the transmission of the incoming application request to the entity application.

13. The computer program product of claim 10, wherein the at least one processing device is configured to analyzes, via the artificial intelligence engine, the data associated with the execution of the mirrored incoming application request in the one or more virtual environments to determine if the mirrored incoming application request is malicious based on one or more exposure indicators.

14. The computer program product of claim 10, wherein the one or more actions comprise:
stopping analysis if the artificial intelligence engine determines that the mirrored incoming application request is not malicious;
transmitting the analysis to a user associated with the entity application for review if the determination by the artificial intelligence engine whether the mirrored incoming application request is inconclusive; and
generating and storing one or more security rules to mitigate exposures associated with the mirrored incoming application request if the artificial intelligence engine determines that the mirrored incoming application request is malicious.

15. The computer program product of claim 10, wherein the one or more virtual environments are generated in real-time.

16. A computer implemented method for generating and operating a cluster of virtual operating environments to mirror incoming application requests, wherein the method comprises:
receiving an incoming application request associated with an entity application associated with an entity;
mirroring the incoming application request to generate a mirrored incoming application request;
parallelly transmitting the incoming application request to a security application and the mirrored incoming application request to a mirrored environment controller application,
wherein the security application determines if the incoming application request is malicious before the incoming application request is transmitted to the entity application,
wherein in parallel to steps performed by the security application, the mirrored environment controller application (i) creates one or more virtual environments for executing the mirrored incoming application request, (ii) executes the mirrored incoming application request in the one or more virtual environments, (iii) monitors and records execution of the mirrored incoming application request in the one or more virtual environments, (iv) transmits data associated with the execution of the mirrored incoming application request in the one or more virtual environments to an artificial intelligence engine, (v) analyzes, via the artificial intelligence engine, the data associated with the execution of the mirrored incoming application request in the one or more virtual environments to determine if the mirrored incoming application request is malicious, and (vi) performs one or more actions based on determining if the mirrored incoming application request is malicious.

17. The computer implemented method of claim 16, wherein the security application determines if the incoming application request is malicious based on one or more security rules.

18. The computer implemented method of claim 16, wherein the security application determines that the incoming application request is malicious and blocks the transmission of the incoming application request to the entity application.

19. The computer implemented method of claim 16, wherein the one or more actions comprise:
stopping analysis if the artificial intelligence engine determines that the mirrored incoming application request is not malicious;
transmitting the analysis to a user associated with the entity application for review if the determination by the artificial intelligence engine whether the mirrored incoming application request is inconclusive; and
generating and storing one or more security rules to mitigate exposures associated with the mirrored incoming application request if the artificial intelligence engine determines that the mirrored incoming application request is malicious.

20. The computer implemented method of claim 16, wherein the one or more virtual environments are generated in real-time.
